(19) United States
(12) Patent Application Publication
(10) Pub. No.: US 2023/0288732 A1
(43) Pub. Date: Sep. 14, 2023

(54) ILLUMINATED NOVELTY EYEGLASS FRAME

(71) Applicant: Lorraine Melody Hsu, Santa Ana, CA (US)

(72) Inventor: Lorraine Melody Hsu, Santa Ana, CA (US)

(21) Appl. No.: 17/693,627

(22) Filed: Mar. 14, 2022

(51) Int. Cl. G02C 11/04

(52) U.S. Cl. CPC G02C 11/04

(57) ABSTRACT

An illuminated wearable item includes a frame configured to resemble a prescription eyeglass frame. A plurality of bulb sockets for receiving bulbs extend from or are recessed into a top surface of the front of the frame. At least one battery is situated in a compartment in the nose bridge, and connected to the sockets by wires that are either enclosed within the frame. The battery and wires are connected to a switch having a push button or slider that extends through a opening at a top of the ose bridge. A flasher circuit or controller for providing illumination effects may optionally also be positioned in the nose bridge.

### BACKGROUND OF THE INVENTION

### 1. Field of the Invention

The invention relates to a wearable item with a customizable decorative illumination arrangement. The illumination arrangement includes a plurality of bulb sockets that permit bulbs of different colors and shapes to be installed, and optionally removed and replaced, for providing a variety of multi-color illumination effects and also to extend the life of the wearable item.

The wearable item is in the form of an eyeglass frame with bulb sockets that extend from, or are recessed into, the top of the frame. For safety, all wiring and electrical parts are enclosed within the frame. A variety of different illumination effects may be provided by varying the arrangement of wiring between a power source and the bulb sockets, and by optionally including a flasher circuit or controller to control illumination of individual bulb sockets.

### 2. Description of Related Art

Illuminated novelty eyeglass frames are popular accessories for holiday celebrations and parties, helping participants achieve a party spirit and fun atmosphere. The frames typically do not include lenses, and are intended to be worn for decorative effect rather than to correct vision.

The conventional illuminated novelty eyeglass frames rely on molded-in or encapsulated light sources. When a light source comes inoperative, the wearable item must be disposed of by the user. In addition, the light sources are generally uniform in color, without selectable patterns, colors, or illumination effects. An example of a conventional illuminated eyeglass frame, in which LED light sources are enclosed within the eyeglass frame, is described in U.S. Patent Publication No. 2020/0124877, entitled “Confetti Inlaid Wearable Novelty Items.”

In some wearable items, such as headbands, sockets are provided to receive the light sources. An example is described in U.S. Pat. Nos. 10,561,217, entitled “Illuminated Headband.” Because of the need for flexibility, and resulting vulnerability to breakage, the battery and wiring for the bulb sockets are provided on the outside of the headband. Such an arrangement is not suitable for use in novelty eyeglass frames, which are relatively narrow in comparison with a headband, due to difficulty in locating electrical parts and wiring on the outside of the frame, the potential for electrical shock if electrical parts come into contact with the wearer, and also because the wiring and electrical parts detract from the aesthetic effect of the eyeglasses. As a result, eyeglass frames have not previously been able to include replaceable bulb sockets.

A need therefore exists for an illuminated novelty eyeglass frame in which electrical parts and wiring are completely enclosed within the frame, and yet that provides bulb sockets that extend out of the frame, allowing a user to vary the arrangement of light sources and/or bulbs, to achieve different color and illumination effects and, in case of replaceable light sources, to extend the useful life of the illuminated eyeglass frame by replacing burnt-out light sources or light source-containing bulbs.

### SUMMARY OF THE INVENTION

It is accordingly a first objective of the invention to provide a wearable item, in the form of an illuminated novelty eyeglass frame, that is capable of providing a variety of illumination effects.

It is a second objective of the invention to provide an illuminated wearable item, in the form of an illuminated novelty eyeglass frame, that is attractive, durable, and safe.

It is a third objective of the invention to provide an illuminated eyeglass frame capable of multiple illumination effects, by including sockets at an upper surface of the frame to permit selected light sources and/or bulbs to be varied or replaced and, optionally, by also providing a flashing control circuit or processor, and in which all electrical parts, including a power source and wiring, are concealed within the eyeglass frame for safety and an improved appearance.

In an exemplary embodiment of the invention, the illuminated novelty eyeglass frame includes a plurality of molded-in sockets extending from or recessed into the top of the frame, a battery provided in an internal compartment situated in the portion of the frame that rests on the wearer's nose (i.e., the nose bridge), an on-off switch having a push button or slider that extends through an opening in top of the nose bridge, and wiring that extends from the controller board to the sockets without being exposed to the outside of the frame.

### BRIEF DESCRIPTION OF THE DRAWINGS

FIGS. 1-3 are front views showing an illuminated novelty eyeglass frame constructed in accordance with the principles of a preferred embodiment of the invention to, include different wiring arrangements shown in the respective drawings figures.

FIG. 4 is a rear view of the frame of FIGS. 1-3, provided with different bulbs.

FIG. 5 is a top view of the frame of FIG. 4.

FIG. 6 is a side view of the frame of FIG. 4

### DETAILED DESCRIPTION OF THE PREFERRED EMBODIMENTS

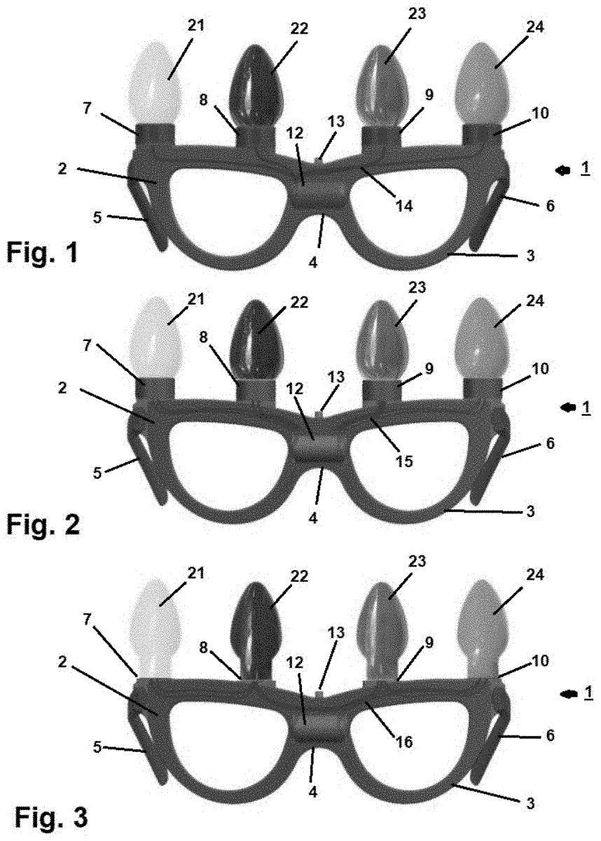

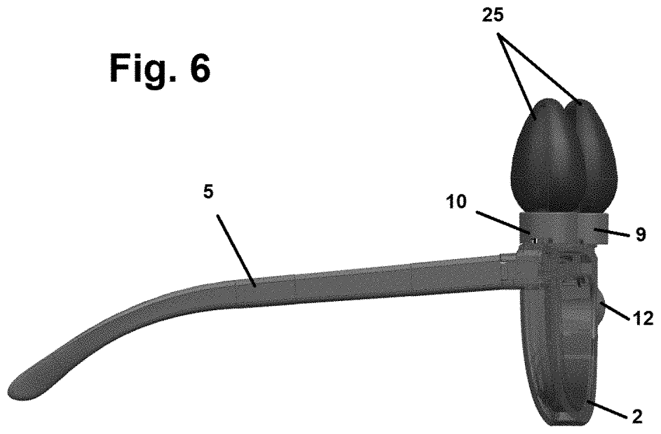

As shown in FIGS. 1-6, a wearable item constructed in accordance with the principles of the present invention includes an eyeglass frame 1 having a two polygonal-shaped sections 2 and 3 that extend around the wearer's eyes and that correspond to the lens-holding sections of a conventional prescription eyeglass frame. Although constructed to resemble corresponding polygonal sections of a prescription eyeglass frame with lenses, sections 2 would normally be left open, without lenses, since the frame is primarily intended for amusement rather than vision correction.

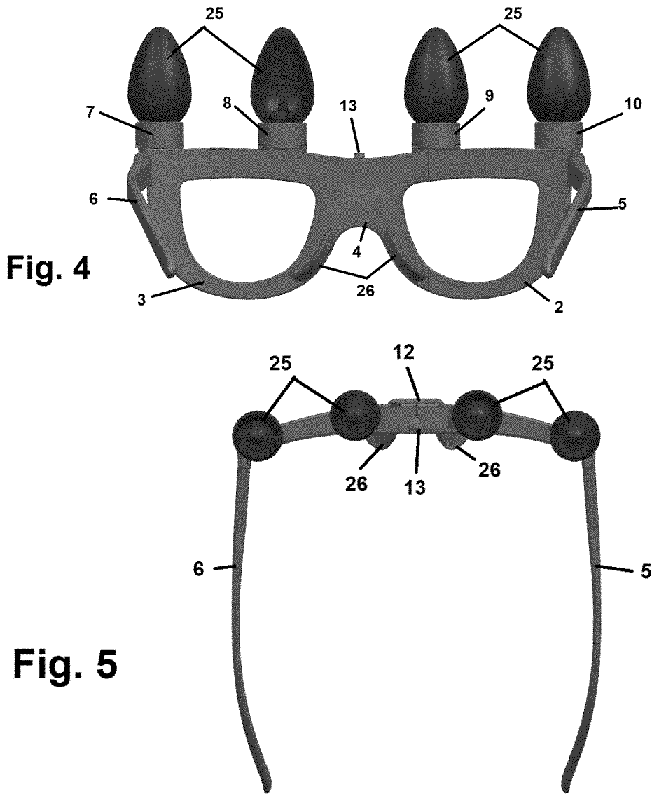

Polygonal sections 2 and 3 are connected by a bridge section 4 that fits over a wearer's nose to support the front of the frame, and that may include optional nosepieces 26, as shown in FIGS. 4 and 5. Earpieces 5 and 6 extend rearwardly from respective polygonal sections 2 and 3 to rest on a user's ears when the frame is worn. Earpieces 5 and 6 are preferably integrally molded with sections 2 and 3 for manufacturing convenience and cost, but may optionally be connected to polygonal sections 2 and 3 by hinges (not shown).

Extending from the top of polygonal sections 2 and 3 are a plurality of bulb sockets 7-10. Sockets 7-10 are, in the example shown in FIG. 1, upwardly extending cylindrical members that are integrally molded with frame sections 2 and 3, and in which are positioned respective contact sets (not shown). The contact sets may be screw-in contacts, bayonet contacts, pin socket contacts, or any other bulb-receiving-and-holding contact type.

The illustrated bulbs 21-24 (FIGS. 1-3) and 25 (FIGS. 4-6) may be conventional incandescent or LED bulbs, and may have different colors and shapes. Each bulb must include a bulb base (not shown) that removably fits within a respective socket, but the configuration and type of bulb is otherwise optional and may be varied without departing from the scope of the invention. In addition, the invention is not limited to a specific eyeglass frame shape or configuration. It will be appreciated that the term “bulbs” encompasses any light source housing through which light from a light source is transmitted, and which may be separately replaceable from the light source itself. For example, it is within the scope of the invention to provide light sources, such as LEDs, that are fixedly connected to the wiring and/or frames, and that are enclosed within “bulbs” that can be removably secured to the sockets and replaced in order to change the color and/or shape of the bulbs.

Included in the nose bridge section 4 is a battery compartment 12, which may contain a cylindrical battery or a plurality of button cells (not shown). Also included in the bridge section 4 is an on-off switch that includes a push button or slider 13 that extends through an opening at the top of the bridge section 4. The switch may be a simple on-off switch or may optionally be connected to an integrated circuit or controller (not shown) that controls supply of power to the bulb sockets 7-10 in such a way as to provide lighting effects such as flashing. The optional integrated circuit or controller may, for example, provide different lighting modes or flashing patterns, such as sequential or random flashing, and/or different flashing frequencies or duty cycles.

In the illustrated embodiment, the battery and switch are sealed within the frame, which may be injected molded and constructed of one or more layers or parts. Optionally, access may be provided to the battery compartment to enable batteries to be replaced, although it is also within the scope of the invention to seal the battery or batteries within the frame without enabling replacement. In addition to enclosing the battery and other electrical parts within the frame, all wiring is encapsulated within the upper portion of the frame to protect the wires from damage.

FIGS. 1-3 respectively show different wiring configurations that are possible in the illustrated embodiment of the invention. For example, in the variation shown in FIG. 1, each bulb socket is connected to the power source by wires 14 that provide a simple series connection that enables the bulbs to be turned on and off simultaneously, but does not provide separate control of individual bulbs to providing multiple flashing effects such as “chasing” or “random” flashing.

On the other hand, in the variation shown in FIG. 2, each bulb is separately connected to the power supply to enable the bulbs to be turned on and off individually and provide multiple flashing effects.

Finally, in the variation shown in FIG. 3, the bulbs are connected in parallel by wires 16, and the sockets 7-10 are replaced by recessed sockets whose tops 17-20 are flush with a top surface of the frame sections 2 and 3.

Although specific embodiments of the invention have been described in detail, those skilled in the art will appreciate that variations and modifications may be made without departing from the scope of the invention.

What is claimed is:

1. An illuminated wearable device, comprising:
an eyeglass frame having a pair of polygonal frame sections configured to surround a user's eyes when worn, a nose bridge connecting the polygonal frame sections and configured to rest on the user's nose, and a pair of ear pieces that extend rearwardly from the polygonal frame sections;
a plurality of bulb sockets situated at a top of, at least, the polygonal frame sections, and configured to receive respective bulbs and connect the bulbs to wiring;
at least one battery compartment situated in the nose bridge and arranged to enclose at least one battery for supplying power to the plurality of bulb sockets through wiring,
wherein the battery and all electrical parts for supplying power to the bulb sockets, including the wiring, is enclosed within the frame and protected from exposure.

2. An illuminated wearable device as claimed in claim 1, wherein the wiring is enclosed entirely within the frame.

3. An illuminated wearable device as claimed in claim 1, wherein the bulbs and/or light sources within the bulbs are removable and replaceable.

4. An illuminated wearable device as claimed in claim 1, wherein a configuration of the wiring varies in different ones of said eyeglass frame, the variations including series, parallel, and separate connections to the bulb sockets.

5. An illuminated wearable device as claimed in claim 1, wherein the sockets are housed in cylinders that extend upwardly from a top surface of, at least, the frame sections.

6. An illuminated wearable device as claimed in claim 1, wherein the sockets are recessed into a top surface of, at least, the frame sections.

7. An illuminated wearable device as claimed in claim 1, further comprising a push button switch that extends through an opening in a top surface of the nose bridge.

8. An illuminated wearable device as claimed in claim 7, further comprising an integrated circuit or controller connected to the wiring to provide illumination effects.

9. An illuminated wearable device as claimed in claim 1, wherein the illumination effects include flashing effects.

10. An illuminated wearable device as claimed in claim 1, further comprising a plurality of bulbs received in respective ones of the sockets.

11. An illuminated wearable device as claimed in claim 1, wherein the plurality of bulbs include bulbs of different colors.
